(19) United States
(12) Patent Application Publication
(10) Pub. No.: US 2011/0247068 A1
(43) Pub. Date: Oct. 6, 2011

(54) Method And Apparatus For Enhanced Security In A Data Communications Network

(75) Inventor: Eric W. Tolliver, Moorpark, CA (US)

(73) Assignee: Alcatel-Lucent USA Inc., Murray Hill, NJ (US)

(21) Appl. No.: 12/751,013

(22) Filed: Mar. 31, 2010

(51) Int. Cl. G06F 11/00

(52) U.S. Cl. 726/22

(57) ABSTRACT

A method and apparatus for enhancing the security of a data communications network. When a packet or other data unit enters the network, an associated geolocation is ascertain and a value representing that geolocation, that is, geolocation information, is inserted into the packet. When a packet is about to leave the network, the previously inserted geolocation information is analyzed, and in most cases, removed, and a decision is made according the analysis as to whether to forward the packet or discard it due to a suspect character. In some cases, suspect packets are instead flagged and forwarded, sometimes in connection with sending a warning to the intended recipient.

### TECHNICAL FIELD

The present invention relates generally to the field of communication networks, and, more particularly, to a method and device for improving the ability of a network to identify data packets of suspicious origin so that they are not accepted or forwarded through the network.

### BACKGROUND

The following abbreviations are herewith defined, at least some of which are referred to within the following description of the state-of-the-art and the present invention.
ACL Access Control List
API Application Program Interface
IEEE Institute of Electrical and Electronics Engineers
IETF Internet Engineering Task Force
IP Internet Protocol
LAN Local Area Network
MAC Media Access Control
QoS Quality of Service
RFC Request for Comments (an IETF term)
VoIP Voice over IP

Modern computers are used for a wide variety of applications, business and personal, government and military. Computers are often connected to one another though a network, such as a LAN or MAN, enabling user communication and the sharing of information and computing resources. Resource sharing may involve, for example, the transmission of data from one computer to another for processing, with some result being returned to the sender or some other entity. It may also involve the transmission of data to a database located elsewhere for collection, processing, or simply safe storage until its retrieval or deletion is desired. User communication may involve well-known applications such as email, instant messaging, and even voice through, for example, a VoIP application.

Networks may be established in a variety of environments. A home network, for example, may include several computers or VoIP-type telephones that in most cases communicate by cable or wireless interface with a modem providing a connection to a carrier network. The carrier network, which of course is much larger than a home network, may connect thousands of such home or business users with each other, with the Internet, or with other carrier networks. An enterprise, such as a business or governmental agency, may interconnect some or all of its computing devices via a network, which may itself be made up of a number of sub-networks.

Network data communications are often accomplished by segmenting data to be transmitted into discreet data units such as packets or frames. Each data unit may then be transmitted separately from source to destination, where the entire data transmission may be reassembled. For this to occur, of course, each data unit contains some indentifying and addressing information in addition to the data itself. This additional information may be included in a header field in such a manner that it can be understood by the recipient.

In most networks of any size, each computer is not directly connected to each other computer, but rather a number of intermediate nodes are established to receive data units and forward them toward their intended destination. This is typically done according to standard protocols, although each network may employ its own data communication techniques as well.

Many large networks have multiple entry points, and data communications may arrive from other networks or entities not associated with the network itself. Security is therefore a concern. Malicious communications are sometimes sent in an attempt to steal information through a network or disrupt the operation of a network or the computers connected to it. Not unexpectedly, a number of security techniques are already being used in most networks.

Note that the tools, techniques, or schemes described herein as existing, possible, or otherwise are presented as background for the present invention, but no admission is made thereby that these tools, techniques, or schemes were heretofore commercialized or known to others besides the inventors.

One such technique involves accepting data only from known sources, for example as identified in the packet header information. Unfortunately, malicious entities may spoof data units in an effort to make them appear to originate from a legitimate source, or at least from one different than they are actually being sent from so that the hacker's true identity cannot be discovered.

ACLs may be used in some cases to indicate at each network node that path though the network that legitimately addressed data units should take. Packets arriving on the ‘wrong’ path, for example, could then simply be discarded. The problem with this solution is that the number of rules needed for implementation tends to be large and in most environments ACL size is restricted.

Accordingly, there has been and still is a need to address the aforementioned shortcomings and other shortcomings associated with security in data communication networks. These needs and other needs are satisfied by the present invention.

### SUMMARY

The present invention is directed to a method and apparatus for securing a data communication network using geolocation information inserted into data units, such as packets or frames, preferably at the point where they enter the network.

In one aspect, the present invention is a method of securing a data communication network including receiving a data unit at a second network node, detecting geolocation information in a header field of the data unit, determining whether to process the data unit based at least in part on the detected geolocation information, if any, that has been inserted into the packet. In this aspect, the geolocation information, if present, was in most cases previously inserted by a first network node, which is usually but not necessarily a different node than the second network node. If the second network node determines that the data unit should be forwarded to an entity without the network, then in most embodiments it will strip the previously-inserted geolocation information from the data unit.

In another aspect, the present invention is a method of securing a data communication network including receiving a data unit, determining a geolocation associated with the arrival of the data unit, inserting a value, typically in a data unit header, associated with the determined geolocation, and forwarding the packet toward its intended destination. The geolocation associated with the data unit is usually the geographical location of the entity that transmitted the data unit to the network.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a schematic diagram illustrating a data communication network according to an embodiment of the present invention;

FIG. 2 is a flow diagram illustrating a method of securing a network according to an embodiment of the present invention;

FIG. 3 is a simplified block diagram illustrating selected components of a first network node according to an embodiment of the present invention;

FIG. 4 is a flow diagram illustrating a method of securing a network according to an embodiment of the present invention;

FIG. 5 is a simplified block diagram illustrating selected components of a second network node according to an embodiment of the present invention; and

FIG. 6 is a flow diagram illustrating a method of securing a network according to another embodiment of the present invention.

### DETAILED DESCRIPTION

The present invention is directed to a manner of efficiently securing a data communication network. More specifically, embodiments of the present invention may be implemented to enhance network security by discriminatory processing of data units such as packets or frames based on the geolocation information, if any, that has been inserted into the data units.

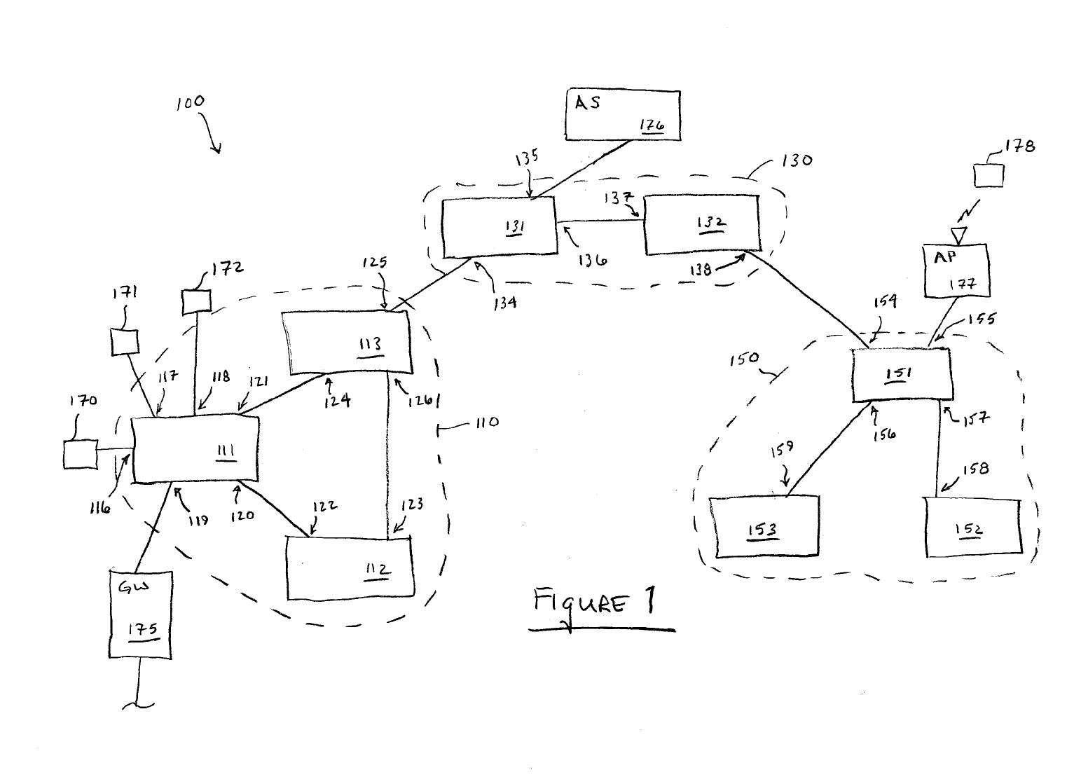

In one embodiment, the present invention is a system for enhancing network security in a data communication network. FIG. 1 is a schematic diagram illustrating a communication network 100 according to an embodiment of the present invention. As can be seen in FIG. 1, network 100 includes a number of network nodes, in this case divided into subnetworks. This may correspond, for example, to the network of an enterprise having offices in a number of different buildings, perhaps located in different cities. Also shown in FIG. 1 are a number of network client devices, which may be fixed or mobile devices belonging to, for example, employees of the enterprise. For the purpose of describing the present invention, these client devices will not ordinarily be considered part of the network 100. This does not mean, of course that the client devices do not benefit from the enhanced network security afforded by the present invention; in fact, they may be the primary beneficiaries.

Network 100 includes subnetworks 110, 130, and 150. Subnetwork 110 includes network nodes 111, 112, and 113, subnetwork 130 includes network nodes 131 and 132, and subnetwork 150 includes network nodes 151, 152, and 153. Network 100 is of course exemplary; in an actually network, there may be more or fewer network nodes, and each subnetwork may include any number of nodes. In some networks, no subnetworks are defined.

In the embodiment of FIG. 1, each network node is assumed to have a number of ports. Network node 111, for example, has three ports, referred to in FIG. 1 as 116 through 118, which are connected to client devices 170, 171, and 172, respectively. In addition, port 119 of network node 111 is connected to another network (not shown) via a gateway node 175. The other network may be, for example, the Internet or the network of a communications carrier. Finally, port 120 of network node 111 is connected directly with port 122 of network node 112, and port 121 of node 111 is connected with port 134 of network node 113. Network nodes 112 and 113 are also connected via a connection between port 123 of node 112 and port 126 of node 113. Note that in most actual implementations, nodes 112 and 113 could, similarly to node 111, be connected to a number of other network nodes, client devices, and other entities; these other ports and devices are simply omitted from FIG. 1 for clarity.

As shown in FIG. 1, subnetwork 110 in this embodiment communicates with subnetwork 130 via a direct connection between port 125 of node 113 and port 134 of node 131. Likewise, port 138 of network node 131 is connected directly to port 154 of network node 151 in subnetwork 150. In other networks (not shown), the subnetworks may not be directly connected in this fashion, but instead rely on multiple components or carrier networks for connectivity.

Within subnetwork 130 of FIG. 1, illustrated network nodes 131 and 132 communicate via a connection established between respective ports 136 and 137. In addition, network node 131 is connected at port 135 to an application server 176. Here the application server 176 is shown as being without subnetwork 130 and network 100, but in other implementations it may be a part of the network. In some cases, application server 176 may be operated by an administrator different than the one operating network 100, but nevertheless “trusted”, and in that sense selectively considered a component of network 100 for purposes of the present invention.

In subnetwork 150, network node 151 is similarly connected at port 155 with access node 177, which for purposes of illustration is shown communicating with wireless device 178 over an air interface. In the subnetwork, node 151 also communicates with network nodes 152 and 153 via a connection between ports 157 and 158, and ports 156 and 159, respectively. Again, the many other ports and connections that would typically be present are not shown for clarity. The configuration of network 100 is exemplary; many variations are possible.

Using network 100, for example, the wireless device could communicate with client device 170 or 171, or both, and access application server 176. These communications are assumed to be digital, and the data communicated is segmented into data units such as packets or frames for transmission. Each data unit includes a header containing, among other things, the identity or address of the sender and the intended recipient. This would be the case, for example, for communications between client 170 and application server 176. Unfortunately, it is possible that a malicious entity could determine the address of application server 176 and “spoof” packets sent to client 170 with the intent of disguising their true origin. This might be done, for example, to intercept communications, provide false information, or even introduce a computer virus.

Naturally, network operators are interested in preventing this kind of attack. In accordance with the present invention, to secure the network, that is, to enhance security, network nodes 111 and 131 (and preferably all of the nodes in network 100) are configured to provide a way to confirm that data purporting to be from application server 176 actually originated there. This configuration and its operation will now be explained in more detail.

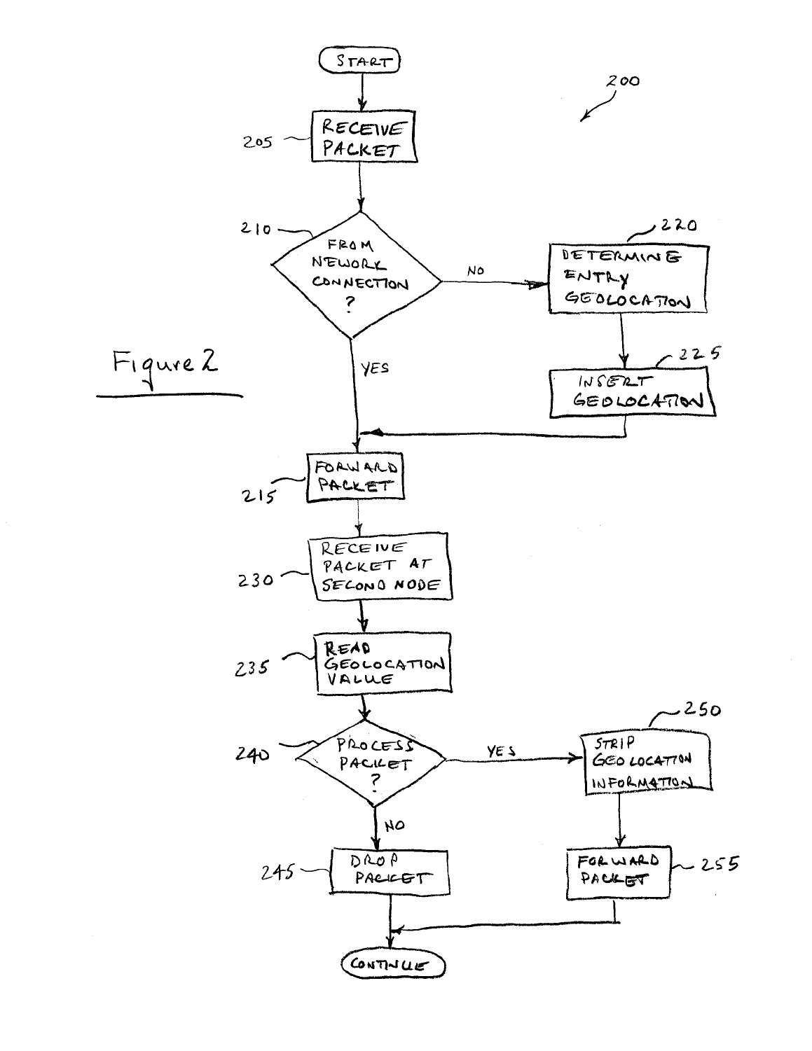

FIG. 2 is a flow diagram illustrating a method 200 of securing a network according to an embodiment of the present invention. In this embodiment, geolocation information is determined when a packet enters the network, for example at network node 131 shown in FIG. 1 from application server 176. This information is then inserted into the packet prior to its being forwarded, for example to network node 113. At START is it presumed that the components necessary for operation of the present invention are available and operational. The process of method 200 then begins when a packet is received (step 205) at a first network node. As mentioned above, each node in the network may be but is not necessarily identical, and identically configured, to each of the others. The term “first network node” is being used herein for convenience to designate, in describing a method according to the present invention, the node at which the exemplary packet being operated on enters the network. In this embodiment, the data unit operated on is a “packet”, though operating on other types of data units may be performed in other embodiments. The process may be applied to all or only selected incoming packets.

In the embodiment of FIG. 2, after the packet is received, the receiving node determines (step 210) whether it is from within or without the network. If the packet was received on a port associated with a trusted connection, for example one associated with another known network node, then it is presumed to be from within the network. In this case, it is simply forwarded (step 215) toward its intended destination. In an alternate embodiment (not shown), the determination at step 210 includes determining whether the received packet contains inserted geolocation location information. If it does not, then it may be treated as if it was received from without the network even if it is received on a trusted connection.

In this embodiment, if the packet was received from without the network, its entry geolocation is ascertained (step 220). In many cases this will simply be the geolocation of a port having a wired connection (copper or optical fiber, for example) whose geolocation is known and constant. Port location may be determined, for example, using the methods described in U.S. patent application Ser. No. 12/106,961. In the case of a wireless network, the entry point may be more difficult to ascertain, but may include the latitude, longitude, and altitude of the wireless device as best as it can be determined by the network of access points (not shown in FIG. 1) and the switch and port of the receiving access point (for example, access point 17 shown in FIG. 1). Unless specifically recited, however, no particular method of geolocation determination is required for use with a particular embodiment.

Note that as used herein, “geolocation” means the actual geographic location (with as much precision as in desirable in a particular network) of the packet's entry into the network, and it is used to avoid confusion with other common uses of the word “location” (such as a memory location). When the entry is deemed to occur, however, may vary from implementation to implementation.

In the embodiment of FIG. 2, once the entry geolocation (actual or deemed) has been ascertained, a value associated with that location is inserted (step 225) into the packet, preferably in one of the optional fields that are usually present in a specified data unit structure. Of course, if a geolocation field is specified in an applicable specification, the geolocation information value would ordinarily be inserted there. And in some embodiments, it is not necessary to insert geolocation information into each data unit. In any event, once the geolocation information, if any, has been inserted, the packet is then forwarded (step 215) toward its intended destination.

As the packet traverses the network (not separately shown in FIG. 2), it may pass through any number of network nodes, such as switches or bridges (see, for example, network 100 of FIG. 1). In the embodiment of FIG. 2, it is presumed that each successive node simply forwards the packet on as arriving from a trusted network connection and being forwarded on another. When the packet arrives at the node from which it is to exit the network, however, additional processing occurs. For convenience this node will be referred to as the “second node”. Note here that the first node and the second node could be referred to as the “entry” and “exit” nodes, in reference to their being the nodes where the packet respectively enters and exits the network. In other embodiments, however, the functions herein described for each node may be performed by other nodes within or without the network, either instead of or in addition to the nodes where packets actually enter and exit. And as alluded to above, in some implementations the entry and exit points may be variously defined.

In the embodiment of FIG. 2, when the packet arrives at the second node (step 230), the geolocation value is read (step 235), and a determination is made (step 240) whether to process the packet. If for some reason a determination is made not to process the packet, then the packet is dropped (step 245). If, on the other hand, the packet is to be processed, then in this embodiment the geolocation is stripped (step 250) and the packet is forwarded on toward its intended destination, for example a user PC, an application server, or another network. Again, note that in some implementations, less than all of the arriving packets may be read or processed. In this embodiment, once the packet is either dropped or processed, the method continues with the processing of additional received packets, if any.

Referring to an earlier example, in this way a packet entering the network 100 at network node 131 from, say, application server 176, may have a value associated with the geolocation of server 176 (or of port 135 itself) inserted into the packet before it is forwarded to node 113. When the packet arrives in node 111, the geolocation information may be used to help verify that the packet actually originated at application server 176 as it purports.

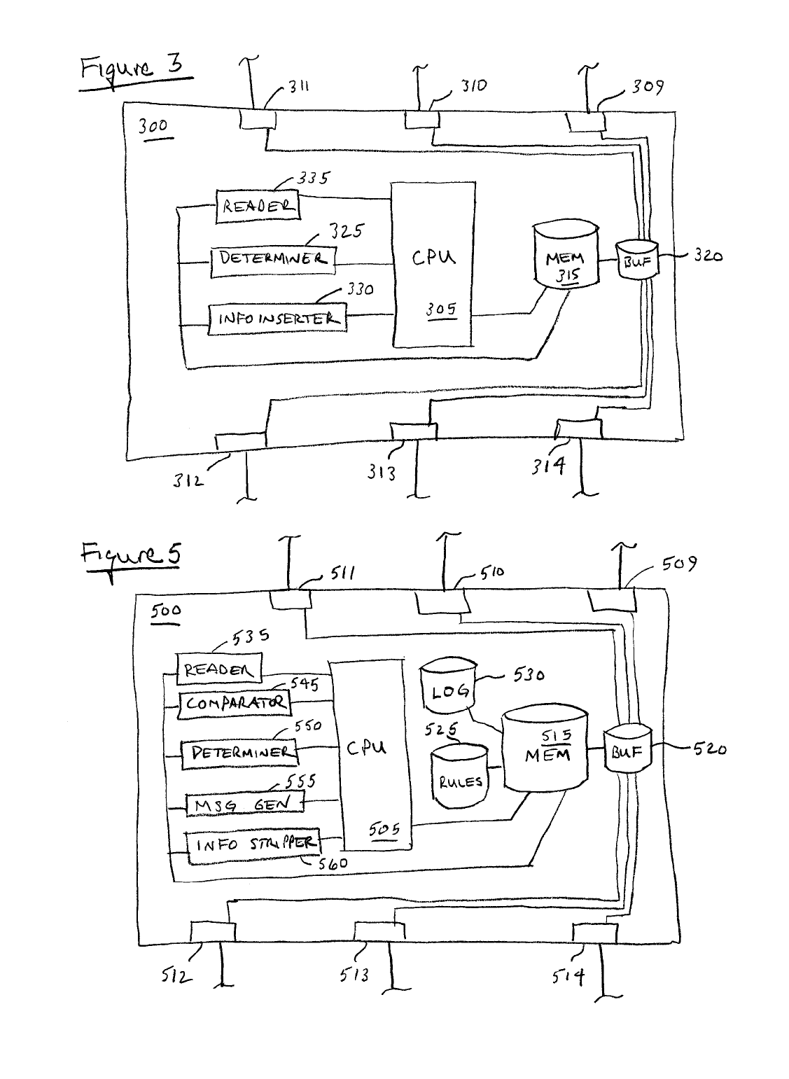

FIG. 3 is a simplified block diagram illustrating selected components of a first network node 300 according to an embodiment of the present invention. As above, the term “first node” is used in reference to a node operating on a packet (or other data unit) that is just entering the network, which is typically though not necessarily the case. First network node 300 includes a number of ports, in FIG. 3 referred to as 309 through 314. Ports 310 through 315 may be connected to other network nodes, or to components without the network such as gateways to other networks or user devices (not shown in FIG. 3).

In the embodiment of FIG. 3, first network node 300 also includes a CPU 305 for controlling operation of the node's components. Memory 315 is provided for storing data and general instructions for the operation of first network node 300. Note that the CPU 305 and memory 315 may be shared with other nodes, especially those physically close together, and may not be physically located within node 300 itself. Illustrated separately is a buffer 320 for buffering received packets while they are being operated on, either according to the present invention or otherwise. In accordance with this embodiment of the present invention first network node 300 includes a location determiner 325 for ascertaining the geolocation at which each packet, or each of selected packets, entered the network. Once the geolocation of packet entry has been determined, location inserter 330 inserts geolocation information such as a value corresponding to the determined geolocation into one or more header fields of the packet being operated on. In this embodiment, a geolocation reader is also present for reading the geolocation information, if any, in a received packet.

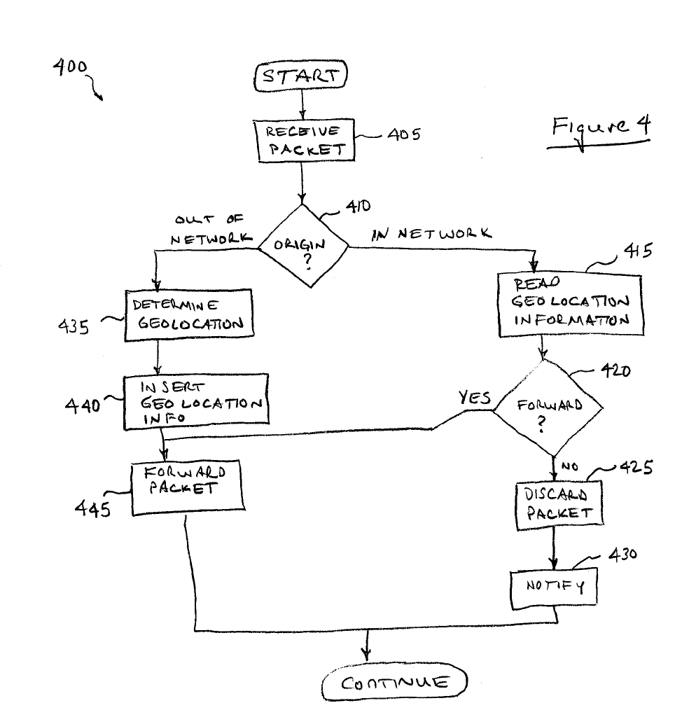

FIG. 4 is a flow diagram illustrating a method 400 of securing a network according to another embodiment of the present invention. Again, at START is it presumed that the components necessary for operation of the present invention are available and operational, for example, the components illustrated in the embodiment of FIG. 3. Here it is also noted that method 400 is comparable though not necessarily identical to a portion of method 200 illustrated in FIG. 2. The process of method 400 begins in the similar fashion with receipt (step 405) of a packet on a port associated with a network node. In the ordinary course (not shown), the network node would determine in some way where to forward the packet so that it makes progress toward its intended destination, and may also perform certain error checking and quality assurance operations. The method of the present invention is performed prior to forwarding the packet.

In this embodiment, a determination is made as to the origin of the packet (step 410). Specifically, the packet at this point the packet is at least classified as originating from within or from without the network. Further classification is possible and sometimes desirable, such as whether the packet originated from another network or a user device. As another example, a determination may also be made as to whether an originating user device is a fixed PC or a wireless mobile station. In the embodiment of FIG. 4, if the packet originated from within the network, the geolocation information within the packet, if any, is read (step 415). Note that it is generally expected that packets received from another network node will contain geolocation information, although in certain instances this may not be the case.

In this embodiment, a determination is then be made (step 420) as to whether to forward the packet. This decision may be made using a number of factors. In some embodiments, for example, any packet received from a trusted network connection may simply be forwarded on that basis alone. In other cases, if such packets do not contain any geolocation information already, it may be added (perhaps with an indication that it was inserted at a node other than the entry node). Or a decision may be made not to forward the packet based on the geolocation information is does contain. In any event, if the decision is made at step 420 not to forward the packet, then it is simply dropped (step 425). In this case, a notification may be sent (step 430) to the network operator so that corrective action may be taken, if necessary. This step is optional, however, and may or may not be performed based on the reason for discarding the packet. For example, if packets that do not contain geolocation information are consistently being received from within the network, one of the network nodes may not be functioning properly.

In the embodiment of FIG. 4, if it is determined at step 410 that the packet originates from outside the network, then the geolocation associated with its entry into the network is determined (step 435). The geolocation may be determined in a number of ways. It may simply be the geolocation of the port at which it entered, or, to the extent it can be determined, it may be the geolocation of the device from which it was transmitted to the first network node. For a wireless device, for example, this may be the geolocation of the communicating access point or of the wireless device itself. The geolocation of a wireless device may be determined, for example, in terms of latitude, longitude, and altitude.

The geolocation in some embodiments, however, may be an approximation or assignment based on certain criteria. In other words, although the term “geolocation” is used in describing the present invention, there is no level of precision or accuracy required unless explicitly recited in a particular embodiment or apparent from the context of a given claim. In some implementations, a high degree of accuracy may be both desirable and achievable while in others, a rough approximation is sufficient. In some embodiments, this approximation may be based on factors other than the known location of certain nodes or other components.

In the embodiment of FIG. 4, once a geolocation is determined with respect to the packet, it is inserted (step 440) into the packet. That is, a value associated with a given geolocation is placed in the packet, generally in an available header field. Of course, other network components will know where to expect this information, but this knowledge does not have to be publically available. By the same token, the geolocation values may be literal (for example, as a longitude) or they may use a code known only to the network and other trusted entities. In some embodiments, such codes may be changed regularly to prevent others from attempting to forge them.

As mentioned above, the data unit operated on by the method and apparatus of the present invention may be a packet or a frame. These data units are often associated with IP routing (layer 3 of the OSI model) and (layer 2) MAC switching. In a preferred embodiment, the present invention is implemented in a data communication network operating according to a layer 3 IP protocol.

In such an embodiment, the geolocation information could be inserted, for example, in the hop-by-hop option header. As mentioned above, this information is preferably entered when the packet enters the network by the first network node it encounters.

With reference to the RFC 2460 (IPv6) and RFC 791 (IPv4) specifications, the following exemplary format could be used:

| | |
|---|---|
| Option Type | 8 bit selector. 001xxxxx as assigned, in a |
| | preferred embodiment, by specification. |
| | Standardizing the Option Type allows for |
| | interoperability. |
| Option Data Length | 8 bit unsigned int. |
| Flags¹ | 6 bit unsigned. See below for flag bit definitions. |
| Switch port | 10 bit unsigned. Port identifier of where the |
| | packet entered the network. |
| Switch address | 64 bit unsigned. IP address of the switch where |
| | the packet entered the network. |
| Latitude | 32 bit unsigned. Latitude of end device as |
| | determined by 1^{st} switch. |
| Longitude | 32 bit unsigned. Longitude of end device as |
| | determined by 1^{st} switch. |
| Altitude | 16 bit unsigned. Altitude of end device as |
| | determined by 1st switch. |
| | Determines floor. |

¹The flag field is used to indicate the following:

| | |
|---|---|
| Source type | Wireless or Wireline |
| Source location type | External connection or user port |
| Accuracy | No lat long, lat long of switch, lat long of port, |
| | % accuracy of wireless lat long |

In an alternate embodiment, the present invention may be implemented in a network operating according to a layer 2 protocol using MAC switching. In this embodiment, certain standards would have to be established that may differ some from those currently in place in order to ensure proper operation. With reference to the IEEE 802.3 standards, the following exemplary format could be used:

| | |
|---|---|
| Destination MAC | Unchanged |
| Source MAC | Unchanged |
| Ethertype | Replaced with a specific value such as 0x9004. |
| | These are assigned by IEEE Registration |
| | Authority. |
| Old Ethertype | The original Ethertype |
| Flags | 6 bit unsigned. See below for flag bit definitions. |
| Switch Port | 10 bit unsigned. Port identifier of where the packet |
| | entered the network. |
| Switch Address | 64 bit unsigned. IP address of the switch where |
| | the packet entered the network. |
| Latitude | 32 bit unsigned. Latitude of end device as determined |
| | by 1^{st} switch. |
| Longitude | 32 bit unsigned. Longitude of end device as |
| | determined by 1^{st} switch. |
| Altitude | 16 bit unsigned. Altitude of end device as determined |
| | by 1^{st} switch. |
| Payload of packet | |

In this regard, it is noted that some network nodes are capable of functioning according to both layer 2 and layer 3 protocols. With this in mind, it is anticipated that such a node would advantageously also be able to implement the present invention at either layer, although this is not a requirement unless explicitly recited in a particular embodiment or apparent from the context.

The above formats are intended to be exemplary and not limiting. In most embodiments, any format in harmony with existing protocols may be used.

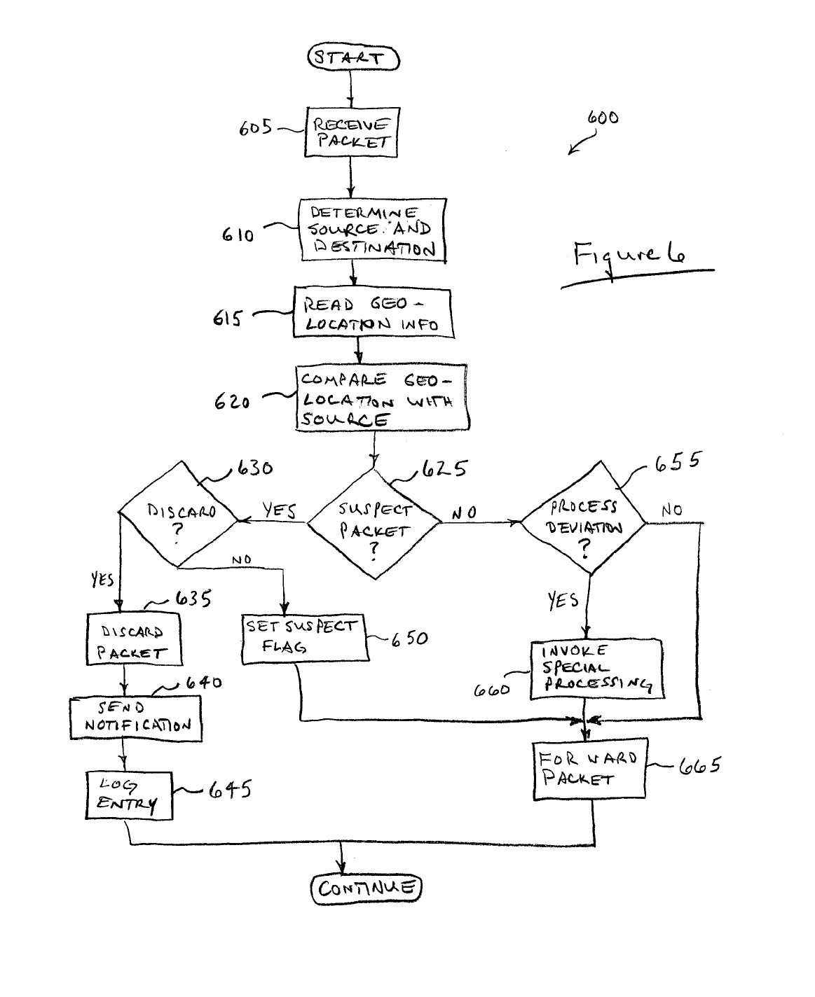

FIG. 5 is a simplified block diagram illustrating selected components of a second network node 500 according to an embodiment of the present invention. As above, the term “second node” is used in reference to a node operating on a packet (or other data unit) that is about to leave the network, which is typically though not necessarily the case. In particular, in some networks geolocation information inserted into packets may be examined at intermediate nodes as well.

In this embodiment, second network node 500 includes a number of ports, in FIG. 5 referred to as 509 through 514. Ports 509 through 514 may be connected to other network nodes, or to components without the network such as gateways to other networks or user devices (not shown in FIG. 5). Second network node 500 also includes a CPU 505 for controlling operation of the node's components. Memory 515 is provided for storing data and general instructions for the operation of first network node 500. Note that the CPU 505 and memory 515 may be shared with other nodes, especially those physically close together, and may not be physically located within node 500 itself. Illustrated separately is a buffer 520 for buffering received packets while they are being operated on, either according to the present invention or otherwise.

In accordance with this embodiment of the present invention, second network node 500 also includes a geolocation information reader 535 for reading and, to the extent necessary, interpreting the geolocation information that has been inserted into packets received at the network node. (In some cases, the second network node may also have inserted the geolocation information itself, in which case the packets are, in this embodiment, processed as received packets.) A geolocation comparator 545 compares the inserted geolocation information with the purported source contained in the packet. Note that the source and destination in a packet are read in the normal course of processing and so this function is not shown explicitly here.

In the embodiment of FIG. 5, a suspect packet determiner 550 determines whether a packet should be considered suspect. This determination may take into account, for example, the result reached by the geolocation comparator or geolocation-related rules stored in rules table 525. A notification message generator 555 generates a message to alert either the network operator or the packet's intended recipient, or both, that a suspect packet has been identified. A geolocation action log 530 is also present for keeping a record of suspect packet determinations and any action taken. Finally, second node 500 includes a geolocation information stripper 560 removes the geolocation information from packets, usually those that are exiting the network.

FIG. 6 is a flow diagram illustrating a method 600 of securing a network according to an embodiment of the present invention. Again, at START is it presumed that the components necessary for operation of the present invention are available and operational, for example, the components illustrated in the embodiment of FIG. 5. The process then begins with the receipt of a packet (step 605) in a network node. By the convention adopted herein, this would be a second network node—that is, one other than the entity through which the packet entered the network. The source and destination in the packet is then read (step 610). Remember that this information is usually provided by the sender of the packet, and may or may not be reliable. A malicious sender may use false source information, for example, in an attempt to disguise the true source or gain unauthorized access. In accordance with this embodiment of the present invention, the geolocation information inserted in the packet, if any, is then read (step 615), and compared (step 620) with the purported source information read in step 610. In accordance with the present invention, the geolocation information, if any, has been inserted by a first network node within the network, or in some cases by a trusted entity without the network.

In the embodiment of FIG. 6, a determination is then made (step 625) as to whether the packet is a suspect packet. This determination may be made taking into account, for example, whether the geolocation information in the packet is compatible with the purported source of the packet. The location of a wireless entity may, for example, be known to the network through the registration process, but packets purporting to come from the entity may have entered the network at a different geographic location. The type of packet may also be considered, for example if a response to a DNS lookup request enters the network from an unusual location. In some embodiments, the destination address information could also be compared to a list of acceptable entry locations, if such a list is available.

If a packet is determined at step 625 to be a suspect packet, then in this embodiment of the present invention it is determined whether to discard the packet (step 630). This in most implementations is done by reference to a set of rules established for this purpose and, in one embodiment, promulgated through the network (not shown in FIG. 6) and maintained at each node where the methods of present invention may be performed. For example, packets with a specific network address may be discarded if they contain geolocation information indicating network entry from a certain location, or alternately if not from a specified location.

In the embodiment of FIG. 6, if it is determined at step 630 to discard the packet, then it is discarded (step 635), and a notification message is sent (step 640). In most cases, this notification message will be sent to at least to the network administrator so that corrective action may be taken if necessary. In addition, a notification message may be sent to the intended destination of the packet, alerting it to the possibility of malicious behavior. Finally, a log entry is made (step 645) for future reference.

If, on the other hand, it is determined at step 630 not to discard the suspect packet, then a flag is set (step 650) in the packet to indicate its suspect nature to future recipients. The flag may simply indicate that the packet is a suspect packet, but may also include some information indicating the circumstances that caused the determination to be made. Note that although not recited in the embodiment of FIG. 6, in an alternate embodiment the notification (step 640) and log entry (step 645) may also be performed with respect to suspect packets that are not discarded. In this embodiment, suspect packets that have been appropriately flagged are then forwarded (step 665) toward their intended destination.

In the embodiment of FIG. 6, if the determination at step 625 is that the packet is not a suspect packet, then a determination is made (step 655) whether a process deviation is in order. In some implementations, rules such as those used to identify suspect packets may also be used to identify packets that should receive special handling of some kind. For example, the QoS for packet handling may be raised, or in some cases lowered (not shown in FIG. 6). Packets originating within a given engineering building, for instance, may be accorded a high QoS by network nodes within the building, but a normal QoS by network nodes in the rest of the network. In another example (also not shown), sampling or logging for network monitoring or troubleshooting may be accomplished using selected packets. Note in this regard that in an alternate embodiment, packets flagged as suspect packets may also be subject to a process deviation determination at step 655, although this is not shown in the embodiment of FIG. 6.

In any case, if it is determined at step 655 that a deviation from the normal process is warranted, the necessary special process or processes are invoked (step 660) prior to forwarding the packet (step 665) toward its intended destination. Note that in some embodiments (see, for example, method 200 of FIG. 2), any geolocation is removed from the packets prior to forwarding them to an entity without the network. In other embodiments (not explicitly shown), this may be performed only on certain packets, for example those containing certain geolocation information or intended for a certain destination.

In should be noted that the methods illustrated in FIGS. 2, 4, and 6 are exemplary and not limiting; some variation is possible without departing from the spirit of the invention. In other embodiments, additional operations may be added or in some cases subtracted. And the operations of each of the claimed methods do not have to be performed in exactly the sequence recited, but rather may be performed in any logically-permissible order absent an express statement to the contrary.

Similarly, FIGS. 1, 3, and 5 depict selected components in an exemplary configuration according to their respective embodiments. Other embodiments may use variations of the illustrated configurations. And some of the illustrated components may in alternate embodiments be combined, or formed of two or more separate components.

Note also that herein, “securing a network” refers to implementing a network security process or apparatus, but does not imply any specific result or level of security or security improvement unless explicitly recited in a particular embodiment.

Finally, note that although the first and second network nodes have generally been described as the nodes at which a given packet or other data unit enters and leaves the network, respectively, in some cases intermediate network nodes may also perform these processes. In other cases, trusted entities may perform some or all of the operations of a claimed method even though they are technically not a part of the network. In yet other cases, some nodes may be considered within the network for some operations and without the network for others. Of course, as mentioned above, a given node may, and preferably is configured to perform the operations of both a first and second node. It is even possible that some packets may, for example, enter and exit the network at the same node and thus be subject to the entire process there.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A method of securing a data communication network, comprising:
receiving a data unit at a network node,
detecting geolocation information in a header field of the data unit,
determining whether to process the data unit based at least in part on the detected geolocation information, if any.

2. The method of claim 1, wherein the detecting and determining operations are performed on every data unit received at the network node.

3. The method of claim 1, wherein the data unit is a packet routed through the network according to an IP.

4. The method of claim 3, wherein the geolocation information, if any, is stored in the hop-by-hop option header field.

5. The method of claim 1, wherein the data unit is a frame switched through the network according to a MAC switching protocol.

6. The method of claim 1, wherein the geolocation information comprises the geographical location of the entity transmitting the data unit to the network.

7. The method of claim 1, further comprising discarding the data unit if a determination is made not to process the data unit.

8. The method of claim 7, further comprising transmitting a notification message if a data unit is discarded based at least in part on the geolocation information.

9. The method of claim 1, further comprising forwarding the data unit to an entity without the network.

10. The method of claim 9, further comprising removing the geolocation information, if any, prior to forwarding the data unit.

11. The method of claim 9, further comprising flagging the data unit as a suspect packet based at least in part on the geolocation information.

12. The method of claim 1, further comprising forwarding the data unit to an entity within the network.

13. The method of claim 12, further comprising assigning a QoS indicator to the data unit based at least in part on the geolocation information.
